(19) United States
(12) Patent Application Publication
(10) Pub. No.: US 2013/0298147 A1
(43) Pub. Date: Nov. 7, 2013

(54) ADVERTISEMENTS BASED ON VIEWER FEEDBACK

(71) Applicants: Daniel Victor KLEIN, Pittsburgh, PA (US); Dean Kenneth Jackson, Pittsburgh, PA (US)

(72) Inventors: Daniel Victor KLEIN, Pittsburgh, PA (US); Dean Kenneth Jackson, Pittsburgh, PA (US)

(73) Assignee: Google Inc., Mountain View, CA (US)

(21) Appl. No.: 13/461,569

(22) Filed: May 1, 2012

(51) Int. Cl. H04N 21/458

(52) U.S. Cl. 725/13

(57) ABSTRACT

A method, and a corresponding system, enable an advertiser to provide advertisements to viewers based on viewer feedback. The method includes providing advertisements for display to a viewer on a first electronic media display device; receiving a favorability signal for a first advertisement displayed to the viewer, the favorability signal originating from a second electronic media display device independent of the first electronic media display device, the second electronic media display device operated by the viewer; computing a favorability value from the favorability signal, the favorability value based on additional favorability signals; comparing the favorability value to a threshold; and if the favorability value is less than the threshold, replacing the first advertisement with a second advertisement for subsequent display to the viewer.

### BACKGROUND

Methods for deciding which advertisements to present to viewers, such as viewers of television programs, may rely on viewing histories of the viewers. These methods do not take into account whether the viewers were actually influenced by the advertisements, or that the advertisements were even watched by the Intended viewing audience, and thus the value of the advertisements may be diminished.

### DESCRIPTION OF THE DRAWINGS

The detailed description will refer to the following figures in which like numerals refer to like objects, and in which:

FIG. 1 illustrates an embodiment of a system in which advertisements are presented to viewers based on viewer feedback;

FIGS. 2A and 2B illustrate embodiments of environments in which advertisements are presented to viewers based on viewer feedback;

FIG. 3 Illustrates an embodiment of a control device useable in the environment of FIG. 2B;

FIG. 4 illustrates an embodiment of a viewer interface useable in the environments of FIGS. 2A and 2B;

FIG. 5 illustrates an embodiment of device components that operate In the environments of FIGS. 2A and 2B;

FIGS. 6A and 6B illustrate an embodiment of a software system distributed among the components of FIG. 5; and

FIGS. 7 and 8 are flow charts illustrating embodiments of methods for providing advertisements to viewers based or viewer feedback.

### DETAILED DESCRIPTION

An advertisement may be any content designed to promote a product or service, or to otherwise give public notice of some subject matter (e.g., a public service announcement, political advertising, a help wanted ad, etc.). An advertisement may include any combination of text, still graphics or images, moving graphics or images (e.g., video, animation), and audio. The advertisement may take on any of a variety of formats, such as a banner, a pop-up, an overlay over other content, a video, and an audio recording, for example.

Advertisements may be classified as targeted or non-targeted (sometimes referred to as default) advertisements. In reality, almost all advertisements may be in some sense “targeted.” For example, advertisements shown during a football game may be selected to appeal to, or present products or services of interest to, the expected football game audience. Thus, in most media, advertisements may involve some form of “targeting.” However, the success of such advertisements has, historically, been difficult to assess and the results of such assessments may be inaccurate.

To improve advertising efficiency, disclosed herein are methods, and corresponding systems that enable the methods that use viewer feedback from watched advertisements to schedule future advertisements. In an embodiment of the methods, a viewer is provided with a mechanism to signal “dislike” or like” for one or more advertisements displayed on a media device such as a television. In another embodiment, only “dislike” signals are collected. A “clearinghouse” service, which is remote from the viewer, and which may be independent of any specific advertiser, product manufacturer, or service provider, receives and analyzes the received like/dislike signals (in an embodiment, a “likeability ratio”) and provides the results of the analysis, as a “favorability” value, or simply the “favorability” of an advertisement, to an advertiser who is considering providing future advertisements for display at the media device. The advertiser then may adjust the schedule of advertisements to ensure a more efficient use of its advertising budget For example, the advertiser may cancel or reduce the frequency of display of underperforming advertisements, provide a different advertisement schedule depending on demographic factors, and target specific advertisements to viewer groups or to specific viewers. Thus, the herein disclosed methods and systems may allow the advertiser to quickly adjust its advertising schedule based on viewer feedback, and to target advertisements with virtually any degree of granularity from essentiality no targeting at the coarsest granularity level down to targeting a specific viewer or a specific display device at the finest granularity level.

The methods and systems also may allow a program or content provider to adjust prices charged for placing advertisements in programs based on favorability values, and actions that may be taken in response to favorability values. For example, an advertisement that receives a low favorability value may be replaced. The program provider may charge more for the replacement advertisement. Alternately, the program provider may charge more for advertisements that will be subject to evaluation as to favorability, since such advertisements may be shown less frequently, or may be replaced, if the favorability value is low. In addition, the cost of evaluating the advertisements may be borne by the advertisers through increased prices for placing such advertisements.

The methods and systems use an automated mechanism for evaluating viewer feedback, optionally in combination with other information, to determine favorability. The automated mechanism includes programs that account for like/dislike signals from each viewer, and other information, when determining future group advertisements, and further includes computer programs that account for a like/dislike signal provided by an individual viewer when targeting advertisements at the finest granularity level. The computer programs may be used to evaluate default advertisements, targeted advertisements, or a combination of targeted and default advertisements. The programs may be used to evaluate advertisements provided with broadcast television, streaming media, pay-per-view programs, prerecorded programs, on-demand programs, video games, and in any form of electronic media that can be displayed to a viewer on a media device. The advertisements may be displayed during scheduled program advertising breaks for broadcast and streaming programs; at regular intervals during, or at the beginning of, on demand or pay-per-view programs; at the beginning of or at intervals during the exposition of video games; and at other times.

The like/dislike signals may be generated by a device used to control the media device. In one embodiment, the control device is a remote control for a television or set top box. In another embodiment, the control device is independent of the television or set top box, and may be a smart phone, tablet, or lap top computer having an installed control application.

The received like/dislike signals, or likeability ratios, may be compared to other like/dislike signals, or other likeability ratios. For example, the ratio of likes lo dislikes for one product advertisement may be compared to the like/dislike ratio for an advertisement for a similar product from the same advertiser or for a similar product from a different advertiser.

When only dislike signals are collected, the dislike signals may be divided into the total number of displays of an advertisement to generate an alternate Likeability ratio. In yet another embodiment, viewers provide only “like” signals, and the like signals may be divided by the total number of displays to generate yet another alternate likeability ratio.

In still another embodiment, viewers provide a favorability signal using a scale: for example, very favorable is assigned a 10 and very unfavorable is assigned a 0. The viewer may use numeric keys to signal favorability in this embodiment. In addition, the viewer may be presented with a free-form text box in which to enter comments.

The like/dislike signals received for an advertisement may be compared with like/dislike signals received from immediately preceding and immediately following advertisements in a specific advertising or commercial break, or across advertising breaks, and the comparison information used to further refine the evaluation of each of the advertisements. For example, if a first advertisement is liked, a second advertisement is disliked, and a third advertisement is liked, a comparison of this result may indicate, even more strongly than a simple, isolated dislike, that the second advertisement may not be effective. For example, an advertisement that is displayed multiple times (e.g., six times) in one media program, may be liked in the first display, ignored (receive no rating) in the second display, and disliked in each of the next four displays. The pattern of one like followed by no comment and then four dislikes indicates the viewer(s) is becoming annoyed with the repeated advertisement.

Advertisements in one vertical (i.e., advertisements having a common theme, generic product, or similar service) may be strongly disliked while advertisements in another vertical may be liked. For example, beer advertisements (the vertical being alcoholic beverages) during a football game may be liked, while diaper and infant advertisements (the vertical being infant products) during the same football game are disliked. These results may provide an indication to advertisers as to what advertisements are affecting the expected audience, and which products and services are best advertised with specific media programs or genre of media programs. A similar analysis may be made for advertisements that are targeted to viewers in a demographic group, viewers in a specific geographic location, and viewers having a history of advertising/likes/dislikes, for example.

The like/dislike signals may be used with any advertisement (default or targeted) displayed through any electronic media. Alternately, the like/dislike signals may be used only with targeted advertisements, only with default advertisements, or only with specifically-designated advertisements, default or targeted.

The viewer may indicate like/dislike at any time during display of an advertisement, in one embodiment, programming in the media device (e.g., television or set top box) may provide an overlay window during display of each advertisement, with a dislike icon (↓) and a like icon (↑). The viewer may indicate dislike or like by depressing programmable or fixed buttons on the media device's remote control, or on fixed or soft keys provided on an independent media device such as a tablet or smart phone.

In an alternative, no overlay window is provided, and the viewer operates the media device remote control, pressing a multi-function button, a programmable button, or a fixed-function button to indicate like or dislike.

In an embodiment, the media device displaying the advertisement receives a dislike or like signal, processes the received signal and sends the processed signal to the remote clearinghouse server. Once the signal is received at the media device displaying the advertisement, the overlay window is removed from display, if no signal is received during display of the advertisement, the overlay window is removed. Alternately, a second media device (e.g. a tablet or smart phone) may send the dislike or like signal to the remote clearinghouse server. In this alternative, the overlay window is removed at the end of the advertisement.

In an alternative embodiment, a media device displaying the advertisement may be provided with computer programming to analyze the like/dislikes (likeability ratio) of an advertisement. This media device also may include a number of alternate advertisements (default or targeted) that are provided by an advertiser and stored in a data store of the media device. When the likeability ratio for an advertisement falls below a threshold value, indicating a disliked advertisement, the programming may execute to select one of the stored, alternate advertisements for display in place of the disliked advertisement during what may be the next scheduled display of the disliked advertisement. In selecting a replacement advertisement from the stored, alternate advertisements, the computer programming may account for other information such as time of day, program, demographic factors, including geographic location, and, with the consent of the device user, identity of the media device displaying the advertisement.

In an embodiment, when a threshold is used, the threshold may be established after a minimum number of ratings have accumulated. For example, the threshold may be established at 80 percent after 1,000 ratings have accumulated: less than 800 favorable ratings out of 1,000 would mean the threshold for likeability has been reached.

In another alternative embodiment, the programming to analyze favorability and select a replacement advertisement may be provided in the independent media device. In this alternative embodiment, the replacement advertisements may be stored in the data store of the media device displaying the advertisement, and the independent media device may store an Index of such alternate advertisements. The independent media device then may signal the media device displaying the advertisement as to which of the stored, replacement advertisements to choose for display.

As noted above, the computer programming for analyzing like/dislike signals and determining favorability may be contained in and executed at a remote, clearinghouse service. The clearinghouse service may be independent of any specific advertiser, product manufacturer, or service provider. Because it is independent, the clearinghouse service may provide likeability information about any displayed advertising without compromising sensitive business information about any specific advertiser, product manufacturer, or service provider. That is, the clearinghouse service may provide a subscription service for any number of advertisers, manufacturers, and service providers. The clearinghouse service may provide a favorability value for each advertisement from a specific advertiser, or for selected advertisements from each advertiser. The favorability may be based on a comparison only of advertisements from the specific advertiser, a comparison of all or selected advertisements from all advertisers, or a comparison of advertisements from a specific vertical, for example.

The clearinghouse service may process the like/dislike signals to generate the favorability value. The processing may be as simple as counting the number of dislikes, comparing the count to a number of advertisement displays, and, if the ratio of dislikes to displays exceeds a threshold, replacing the advertisement.

When a replacement advertisement is provided, and then evaluated, the evaluation may include the favorability of the replacement advertisement relative to the advertisement it replaced.

in an alternative, the clearinghouse service may determine which of many second media devices (e.g., distinguishes a specific media device from numerous media devices) provided the favorability signal based on an advertisement displayed on a first media device by maintaining a mapping between first media devices and second (third, fourth) media devices. To create such a mapping, a viewer may register each of the first and second media devices with an associated service. For example, the viewer may register the first media with a content service. The content service then, with the consent of the viewer, may make this mapping available to the clearinghouse service. The registration may be a one-time registration when the viewer first uses the first and second media devices. The registration may occur each time the viewer turns on the first and second media devices. The viewer may opt out of the mapping scheme at any time subsequent to registration. The registration may be used when the viewer owns only one of the media devices, and is viewing another media device that the viewer does not own. For example, the viewer may register a television in a hotel room with a content service and register the viewer's own media device with the content service to establish a mapping between two media devices that the viewer is using.

The systems and methods disclosed herein may use information related to a specific individual or device. For example, an individual may register with an internet service provider, a content provider, an advertiser, or similar service entity and may, at least initially, provide personally-identifiable information such as name and address. However, to protect the individual's privacy, the systems and methods may use other “anonymized” or “partially anonymized” information. Examples of partially anonymized information may include the IP address of a device or a user name provided by the individual. Anonymized information is any information that sufficiently identifies the individual or device without compromising the individual's privacy, such as a user pseudonym or other abstraction of the individual's actual identity. Furthermore, the systems and methods may provide for the individual to opt in or opt out of a specific aspect of the method at any time. For example, the individual may opt out of a method that collects information about which advertisements were watched.

A media device may send, with the consent of the individual (e.g., via opt out, opt in, or anonymization), identification (ID) information to the service that identifies the media device and or the user at the client. One aspect of sending the information includes a media device signing on with a service. In some cases, the device may automatically sign on using previously provided and stored credentials or other automatic information. Any personally-identifiable information that may be provided by the user may be made anonymous in the system.

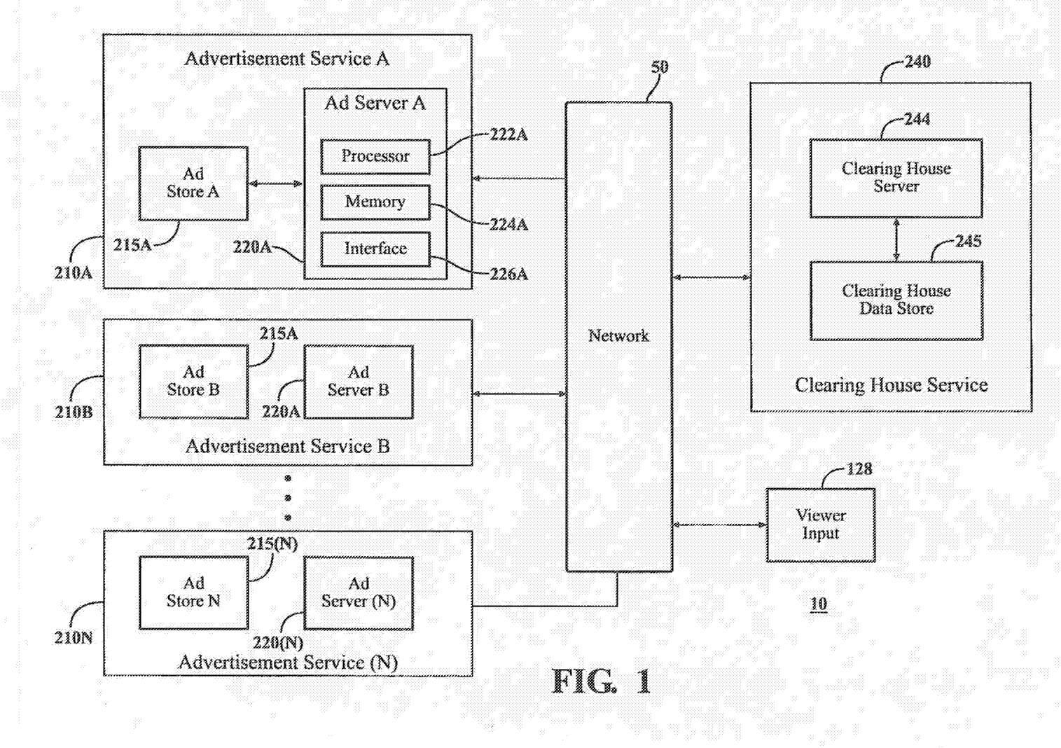

FIG. 1 illustrates an embodiment of a system in which advertisements may be provided to viewers based on viewer feedback. In FIG. 1, system 10 includes multiple advertising services A, B . . . N, labeled 210A, 210B . . . 210N. Each advertising service 210x is operated by an advertiser (not shown). As used herein, an advertiser, depending on the context, refers to a human or to a corporation or similar entity. Each advertising service 210x includes advertising server 220x and advertisement (AD) store 215x. Each server 220x includes processor 222x, memory 224x, and communications interface 228x.

Advertisers may create art advertising campaign and control the placement of advertisements (e.g., by targeting to particular content or categories), bid for advertisement placements, monitor reports associated with the advertising campaign, and make payments associated with the advertising campaign.

The advertisers use the advertising servers 220x to provide advertisements for display in conjunction with the display of programs to viewers. The advertisement servers 220x may access information associated with advertisements and provide tools to advertisers for creating and managing advertising campaigns. The advertisements and related information may be stored in the data stores 215x. The advertising services 210x may receive favorability reports from clearinghouse service 240.

The clearinghouse service 240 includes clearinghouse server 244, which may receive viewer inputs 128, and, executing programming stored in clearinghouse data store 245, may generate favorability reports that may be sent to the advertisement services 210x.

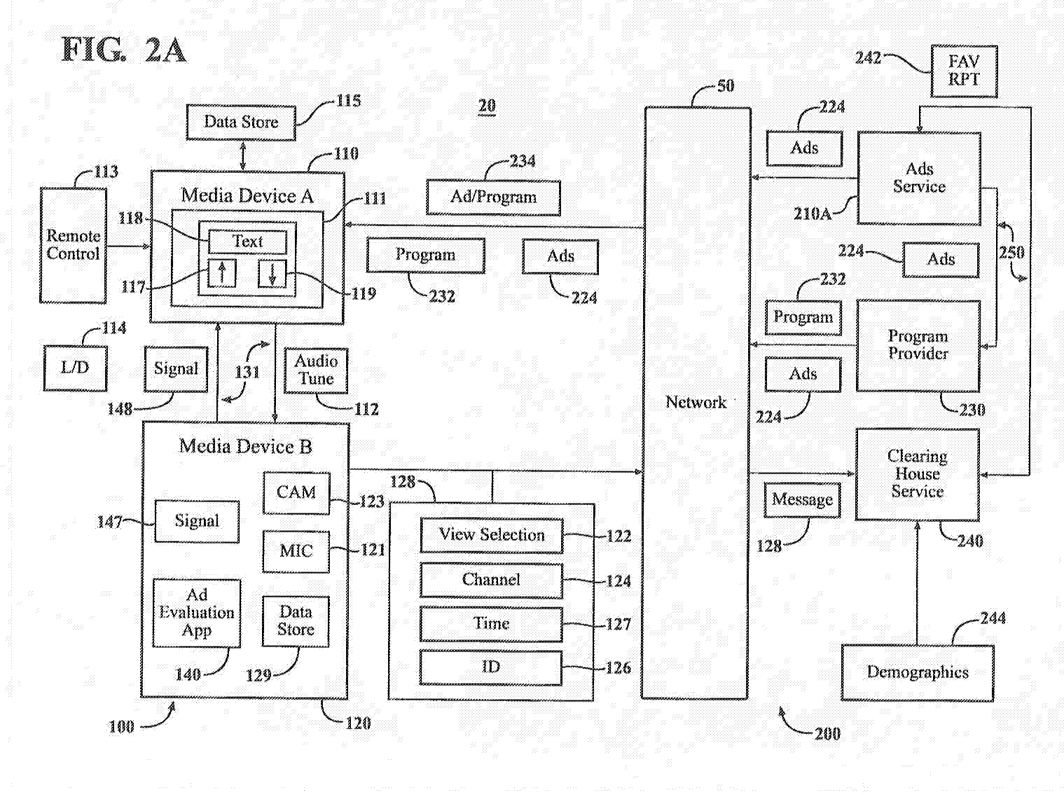

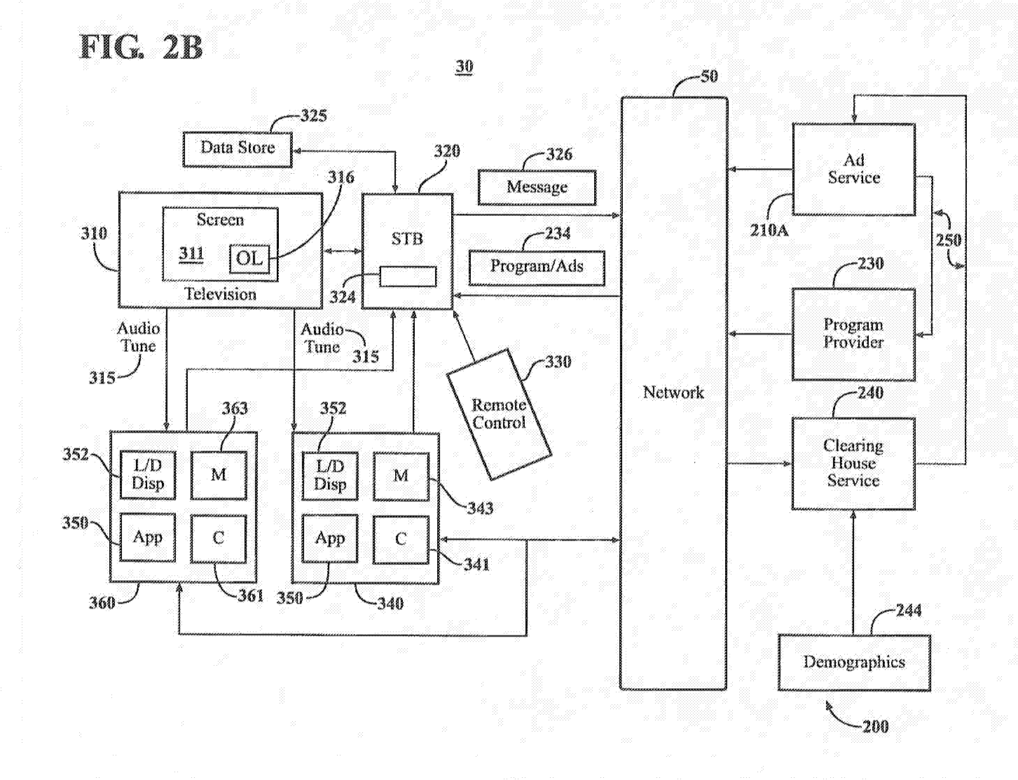

FIGS. 2A and 2B Illustrate embodiments of environments in which advertisements may be based on feedback from viewers. In FIG. 2A, environment 20 includes viewing location 100 coupled to service location 200 by network 50. The network 50 may be any network capable of communications between computing devices and media delivery devices on the one hand, and media display devices on the other hand, in tills regard, media encompasses any form of electronic media, including still and moving images, audio, voice, text, and data. The network 50 may provide for one- or two-way transmission of media including radio; linear broadcast (over-the-air, cable, and satellite) television; on-demand programs; over-the-top media, including streaming video, movies, video clips, and games; and text, email, and still images; and for the transmission of signals, media, messages, voice, and data between the viewing location 100 and the service location 200. The network 50 may include the internet, cellular systems, and other current and future mechanisms for transmission of these and other media. The network 50 may be both wired and wireless.

The viewing location 100 can be any location, including one or more rooms in a personal residence, a hotel room, a public location such as an airport lounge or a sports bar, and a vehicle such as a ship, airplane, train, or motor vehicle. The viewing location 100 includes media device A 110 and media device B 120. The media devices 110 and 120 may be independent of each other In the sense that either media device 110 or 120 may receive, and may transmit, signals over the network 50. The media devices 110 and 120 may communicate with each other over communications path 131.

The service location 200 includes advertisement service 210A, program provider 230, and clearinghouse service 240. The advertisement service 210A, program provider 230, and clearinghouse service 240 may communicate with each other over the network 50, or over a dedicated network 250.

Media device A 110 includes display screen 111, remote control 113, and data store 115, in one embodiment, media device A 110 is a television with an internal processor (that is, an “intelligent” television), or a “basic” television with a set top box, or other processor terminal, coupled thereto. Either an intelligent television or a basic television with a coupled set top box can include internet connectivity. Such televisions are referred to herein as “ITVs.”

The data store 115 stores machine executable computer code for operation of the media device A 110, and also may store advertisements for display to a viewer of the media device A 110. The computer code may be executed either by the intelligent television's internal processor, or the processor in the set top box. The data store 115 also may store data received from the media device S 140 over the communications path 131.

The display screen 111 displays media (e.g., television programs) and advertisements 234 received by the media device A 110 over the network 50. The display screen 111 may display overlay window 118 when an advertisement, for which the clearinghouse service 240 is scheduled to provide a favorability report, is displayed on the media device A 110. The window 118 may include text block 118, like icon 117, and dislike icon 119. The window 116 may not be active, meaning that the icons 117 and 119 may not respond to stimuli, but merely suggest to a viewer that the viewer can, through direct manipulation of a device other than the media device A 110, indicate like or dislike of the displayed advertisement. To generate the window 116, a processor (not shown) in the media display device A 110 may execute programming code stored in the data store 115 at an appropriate time, and remove the window 116 at a later, appropriate time.

The display of the window 116 may be triggered by a signal, or trigger, at the beginning of the advertisement to be evaluated by the viewer. In an embodiment, the processor of the media device A 110 detects a trigger incorporated as a file at a leading edge of the advertisement, and the processor executes the programming code to display the window 116. The window 116 then may be removed from the screen 111. Removal of the window 116 may be triggered by an ending trigger at the trailing edge of the advertisement, or may be removed when either a like or a dislike signal is communicated to the media device B 110. The like or dislike signal may be generated and sent to the media device A 110, for example, by operation of the media device B 120.

As an alternative to forming and removing the window 116 as triggered by the displayed advertisement, the advertisement itself may have incorporated an rating box (not shown), with like and dislike icons. The rating box may be displayed on the screen 111 during display of the advertisement to be evaluated, and may be removed from display when the advertisement ends. The rating box may incorporate features to prompt the individual to rate an advertisement. An example of such a feature may be a thin green border indicating feedback will be accepted.

In either of these two alternatives, the window 116, or the rating box, may serve as a prompt to the viewer to register a like or a dislike for the displayed advertisement.

As an alternative to prompting the viewer to register a like or a dislike for a displayed advertisement, the media device A 110 may display an advertisement without a prompt such as the window 116 or rating box and the viewer, using remote control 113 or media device B 120 may signal a like or dislike.

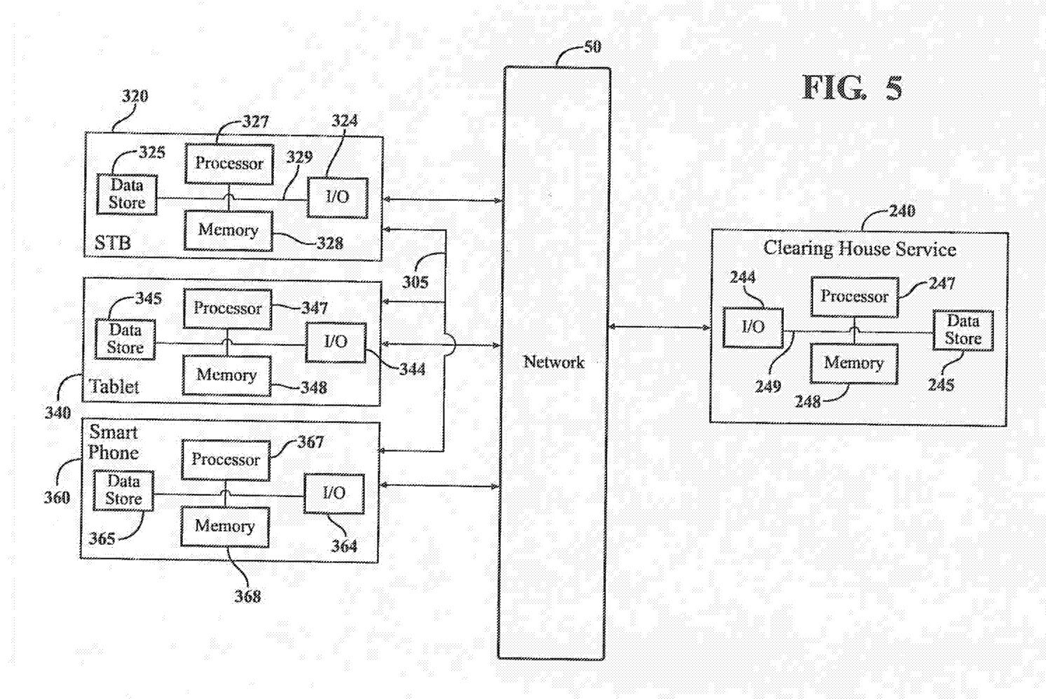

Media device B 120 may include features for detecting external stimuli, including microphone 121 and camera 123, advertisement evaluation application 140, signal generator/transmitter 147, and data store 129. The data store 129 may store executable programming associated with the application 140. When the application 140 is launched, the executable code is loaded into processor memory in the media device B 120. See FIG. 5. In an alternative, the media device A 110 may emit (broadcast) an audio tone 112 that may be detected by the microphone 121 when an advertisement to be evaluated is displayed on the screen 111. The audio tone may be outside a range of human hearing. The audio tone may be a radio-frequency tone. The detected audio tone may be processed in the media device B 120, using the executable code of the application 140. In an alternative, processing the detected audio tone causes the application 140 to activate a selection feature that the viewer than may use to signal like or dislike of the advertisement using signal generator/transmitter 147. For example, in response to display of the window 116, the viewer may activate a like detection button or a dislike selection button that may cause the signal generator/transmitter 147 to send signal 148 to media device A 110, where receipt of the signal 148 may cause the processor in media device A 110 to remove the window 116 from display, in an alternative, no signal is sent to the media device A 110, and the window 116, or rating box, may be removed when the advertisement with which they are associated no longer is displayed on the media device A 110.

In an alternative to producing and detecting a signal such as an audio tone, the media devices 110 and 120 may be time-synchronized so that, for example, media device B 120 “knows” when an advertisement is to be displayed on the media device A 110. The time-synchronization may be established by the individual by registering both media devices on a network, for example. Such registration may be performed each time the media devices 110 and 130 are started, one time, on initial startup of the media devices, or periodically.

In the embodiment shown in FIG. 2A, after the viewer has operated the media device B 120 to indicate like or dislike of an advertisement, the application 140 may generate a message 128 for transmission to the clearinghouse service 240. The message 128 may include the viewer's selection (i.e., either like or dislike) 122, and the channel 124 to which the media device A 110 was tuned (e.g., for television programming), or otherwise an indication of the programming source for the programming displayed on the media device A 110, date and time (time stamp) 127, and Identification 126 of the media device B 120. The data contained In the message 128 may be used by the clearinghouse service 240 to determine the favorability of the displayed advertisement and to generate a favorability report 242, which may be sent to the advertisement service 210A for use by the advertiser in scheduling future advertisements.

In an alternative, the application 140 may be used to generate a favorability value for the displayed advertisement, compare the favorability value to a threshold, and based on the comparison and advertisement data stored in data store 129, instruct the media device A 110 to replace the displayed (and just evaluated) advertisement, with an alternative advertisement. In this alternative, the data store 129 may an advertisement index file that identifies each of a number of advertisements stored in the data store 115. Each advertisement to be displayed on the media device A 110, including the just evaluated advertisement that is to be replaced, may be identified by a unique Identification (UID). The stored advertisement index file in the data store 129 may list replacement advertisements, in a priority order, for each UID. The executable code of the application 140 is used to compare the UID of the advertisement to be replaced with replacement advertisements in the advertisement index file, and to select a replacement advertisement based on the stated priority, or on other criteria. The other criteria may include advertisement metadata, such as length of an advertisement, for example. Thus, in an example, a 45-second advertisement may replace a 30-second advertisement if there is sufficient time available in the designated advertising time slot for which the replaced advertisement was scheduled to run. In this example, if there is not sufficient time, the replacement advertisement may be displayed in a different advertisement time slot for which enough run time is available, and other advertisements may be adjusted as to advertisement time slot for their display.

The program provider 230 may store content and provide the content as programming 232 to viewers. The programming 232 provided by the program provider 230 may include video content, still content and audio content. Video content may include any content that can be visually perceived when played, decoded, or rendered. Video content may be stored or streamed. Video content may include, for example, a live or recorded television program, a live or recorded theatrical or dramatic work, a music video, a televised event (e.g., a sports event, a political event, a news event, etc.), and video voice mail, for example. Video content may be compressed or uncompressed.

The advertisement service 210A may operate in conjunction with the clearinghouse service 240 and the program provider 230 to provide optimum advertising. In particular, an advertiser operates the advertisement service 210A, which includes the advertisement database 215A and advertisement server 22GA (see FIG. 1). The advertiser uploads creatives (i.e., advertisements) to the data store 215A, and may set criteria for display of the uploaded advertisements. The advertisement server 220A selects one or more advertisements 224 from the advertisement data store 215A in accordance with the set criteria. The advertisements 224 may be sent to program provider 230 for incorporation into programming 232, to produce combined programming and advertisement package 234, which then may be delivered to media devices such as the media devices A 110 and B 120. The advertiser also may direct batch loading of select advertisements by one or more media devices, such as the media devices 110 and 120. This batch loading process may ensure that a number of replacement advertisements are located in close proximity to the media devices that are to display the advertisements so that a desired advertisement replacement process may be executed in a timely manner in the embodiment shown in FIG. 2A, the batch replacement advertisements may be stored in the data store 115, while an Index of the replacement advertisements may be provided for storage in the data store 129.

The clearinghouse service 240 may receive favorability data, and other data, in the form of message 128, from the media device B 120 for advertisements displayed on the media device A 110. The clearinghouse service 240 processes the data contained in the message 128 to determine favorability of a specific advertisement, an advertisement campaign from a single advertiser, all advertisements from the single advertiser, or similar advertisements from different advertisers. The clearinghouse service 240 may produce a favorability report 242 that considers the received favorability data, and optionally demographic data 244, when determining favorability and preparing the favorability report 242.

FIG. 2B illustrates another environment in which viewer feedback may be used to determine advertisements to provide to viewers, in FIG. 2B, environment 30 includes viewing location 300 coupled to service location 200 by network 50. The components of the service location 200 are the same as those in FIG. 2A.

Viewing location 300 includes television 310 coupled to set top box 320 or another component for receiving content and/or connecting to a network. The set top box 320 is coupled to data store 325. The television 310 and set top box 320 are operated by remote control 330. Also included at the viewing location 300 are tablet 340 and smart phone 360, both of which are mobile media devices capable of displaying programming and advertisements from devices at the service location 200, and both of which may be independent of the television 310, the set top box 320, and each other. Any additional media device may be used instead of or in addition to one or both of table 340 and smart phone 350.

The television 310 may be an intelligent, internet connected television (ITV) or a basic television. The television 310 includes viewing screen 311. Displayed on the viewing screen 311 may be likeability overlay 316. The television 310 may broadcast audio tone 315 when displaying an advertisement.

The set top box 320 may include a processor, a memory, and a communications input/output device (not shown in FIG. 2B) that connects the television 310 and an external source of signal, turning the signal into content which then may be displayed on the television screen 311. The set top box 320 may be used in cable television and satellite television systems to transform the signal from the cable or satellite to a form that may be used by the television 310. The set top box 320 may allow traditional television broadcast (from terrestrial, satellite, or cable providers) to be brought together with video delivered over the Internet, and with personal multimedia content. The set top box 320 also may enable viewers to access a range of advanced interactive services, such as video-on-demand and time-shifted television, as well as Internet applications, including video telephony, surveillance, gaming, and e-shopping using the television 310. In an alternative, the set top box 320 may be replaced with any device capable of receiving content over the network 50.

The set top box 320 also may enable display of overlay window 316 on the television screen 311. The overlay window 316 may present a viewer with a simple text message, and like and dislike buttons. For example, the overlay window 316 may state “Press (↑) if you like this advertisement and (↓) if you dislike this advertisement.” The processor of the set top box 320 is programmed to interpret a (↑) or a (↓) signal from any of the remote control 330, tablet 340, and smart phone 360 as a like or dislike signal, respectively. The processor is further programmed to remove the overlay window 316 upon receipt of the (↑) or (↓) signal. The data store 325 stores data and programming code for operation of the set top box 320. The data store 325 also may store advertisements that may be displayed on the television 310. One or more of the advertisements stored in the data store 325 may be used to replace a scheduled advertisement whose favorability value falls below a threshold.

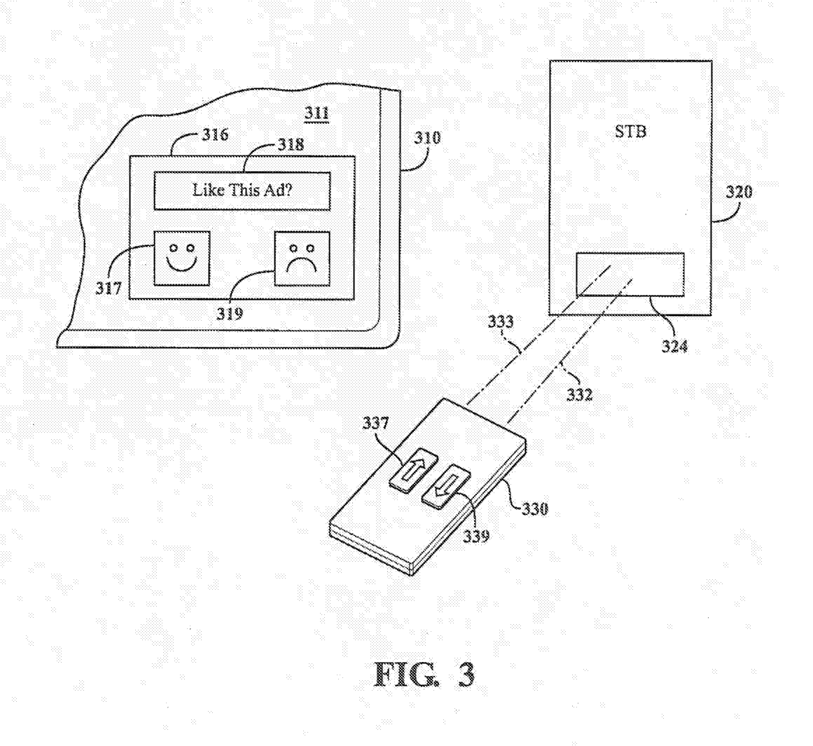

The remote control 330 may include control buttons (hard or soft, programmable or fixed function), programming, and a signal generator or protocol stack (not shown In FIG. 2B) to send a like or dislike selection signal to the set top box 320. The signal may be sent by any appropriate mechanism, including infrared and WiFi, for example. The remote control 330 will be described in more detail with respect to FIG. 3.

The tablet 340 may Include camera 341 and microphone 343, both of which are capable of capturing appropriate signals broadcast from the television 310. The tablet 340 also may include favorability application 350, which, among other features, may display a like/dislike options window 352 in response to the received, broadcast audio tone 315.

The smart phone 360 may include camera 361 and microphone 363, which function in a manner similar to the microphone 343 and camera 341 of tablet 340. The smart phone 360 also includes favorability application 350, which creates options window 352.

The application 350 functions in many respects to the application 140 of FIG. 2A. However, the application 350 also may be capable of generating rating (L/D) window 352 when an appropriate audio tone is received at the host media device (i.e., at the tablet 340 or the smart: phone 360). The rating window 352 may include programmable soft keys (not shown in FIG. 2B) that may be used to generate a like signal or a dislike signal for transmission to the set top box 320. The set top box 320 then may send the like and dislike signals, and other data 326, to the clearinghouse service 240.

As with the media device B 120 of FIG. 2A, in an alternative, the set top box 320 may evaluate the like and dislike signals, and other information, and generate a local favorability value. The set top box 320 then may compare the local favorability value to a threshold, and may replace an under-performing advertisement with another advertisement stored in the data store 325.

FIG. 3 illustrates an embodiment of a control device useable in the environment 20 of FIG. 2B. In FIG. 3, remote control 330 may send like and dislike signals 332 and 333, respectively, to a receptor 324 in set top box 320. The remote control has a fixed key panel that includes multi-purpose keys such as a (↑) key 337 and a (↓) key 339 that send differing signals, which a processor in the set top box 320 may distinguish.

Also shown in FIG. 3 is an embodiment of an overlay window, window 316, in which are shown like (↑) and dislike (↓) icons 317 and 319 corresponding to the keys 337 and 339, respectively. Thus, when the window 316 appears on the screen 311, an individual operating the remote control 330 depresses key 337 to indicate the individual likes the advertisement, and key 339 to indicate the individual dislikes the advertisement.

As an alternative, the remote control 330 may be used to signal like or dislike of an advertisement without the use of overlay window 316 to prompt the viewer. In this alternative, the viewer presses either of the buttons 337 or 339 during the time the advertisement is displayed, the set top box 320 receives the signal and sends the signal, along with an identification of the advertisement, to the clearinghouse service 240,

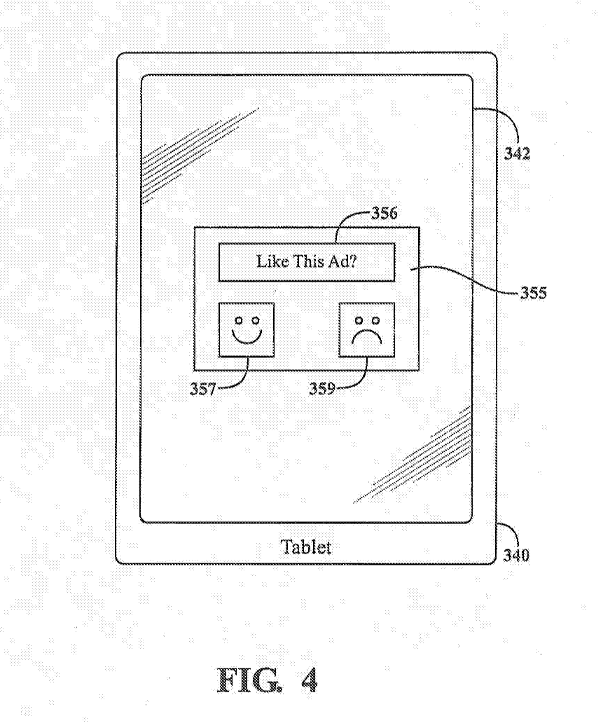

FIG. 4 illustrates an embodiments of a viewer interface useable In the environment of FIG. 2B. In FIG. 4, user interface 355 is formed on a display screen 342 of tablet 340 by execution of program code associated with application 350. The user interface 355 may Include a text message section 356 explaining choices the individual has for expressing likes and dislikes, and soft key 357 for like and soft key 359 for dislike. Touching either soft key 357 or 359 may send an appropriate signal to the set top box 320.

FIG. 5 illustrates an embodiment of hardware components of the devices that operate in the environment 30 of FIG. 2B. In FIG. 5, set top box 320 is shown to include processor 327, memory 328, bus 329, and data store 325. Tablet 340 includes processor 347, memory 348, bus 349, and data store 345. Smart phone 350 includes processor 367, memory 368, bus 369, and data store 365. Clearinghouse service 240 includes processor 247, memory 248, bus 249, and data store 245. The processors 247 and 327 may communicate bi-directionally over network 50. The processors 327, 347, and 367 may communicate among each other In the viewing location 300 using local network 305, which, in an embodiment, may be a local wireless loop.

In FIG. 5, the term processor encompasses all kinds of apparatus, devices, and machines for processing data, including by way of example a programmable processor, a computer, a system on a chip, or multiple ones, or combinations, of the foregoing. The processor may include special purpose logic circuitry, e.g., an FPGA (field programmable gate array) or an ASIC (application-specific integrated circuit). The processor also may include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

In FIG. 5, the term data store refers to a physical data storage device (e.g., a computer or machine-readable storage medium), such as a hard disk, an optical disk, magnetic tape, and other hardware devices that are capable of persistent storage of data and program code. In general, memory refers to a physical device capable of temporary storage of data and computer cods. Unlike a data store, memory may be volatile, and in many cases, removal of power from the memory results in a loss of data and code from the memory. Memory may be embodied as an EPROM, flash memory, and similar physical structures. A data store and memory both may be referred to as computer readable medium. That is, an associated processor reads data from, and executes program code stored in, a data store or a memory. The data store (e.g., the computer or machine-readable storage medium) does not include a transitory signal.

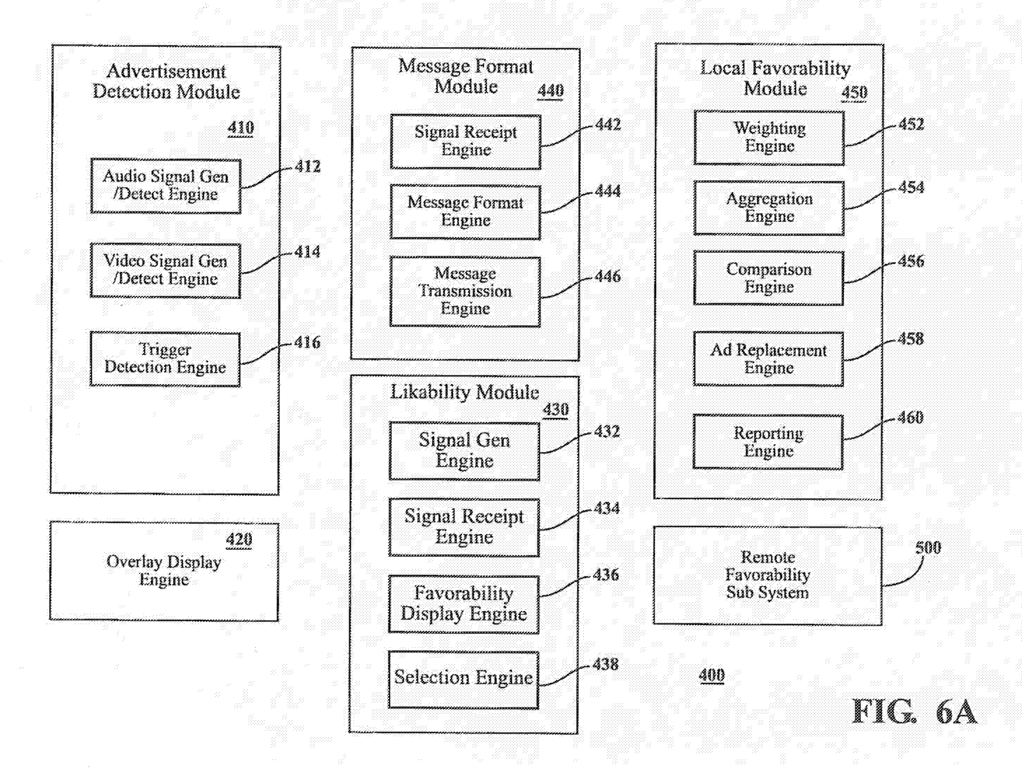

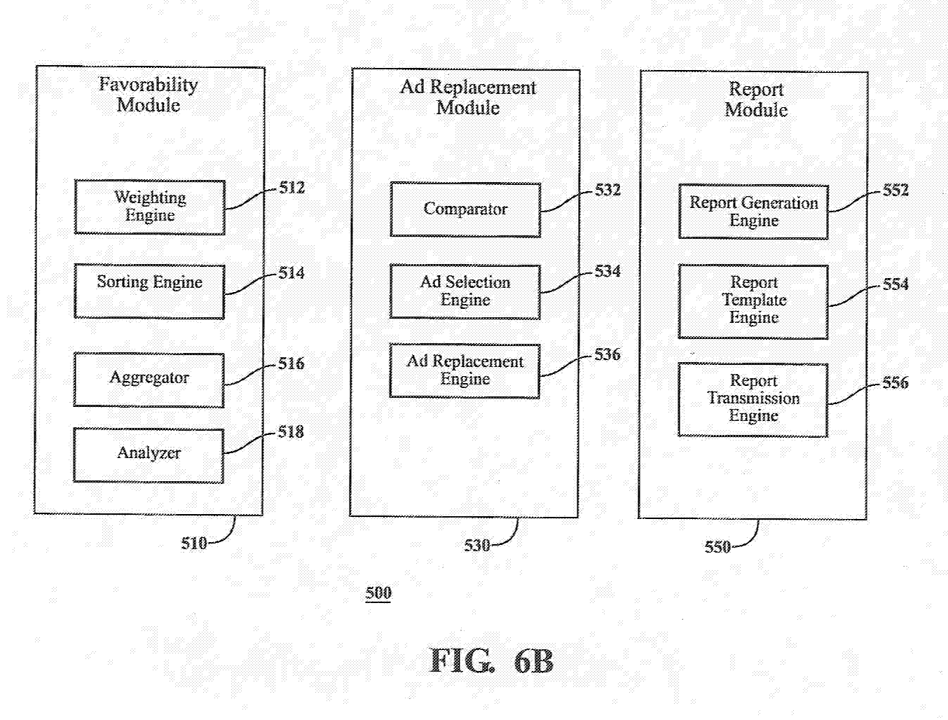

FIGS. 6A and 6B Illustrate an embodiment of a software system distributed among the components of FIG. 5. In FIG. 6A, software system 400 includes advertisement detection module 410, overlay display engine 420. Likeability module 430, message format module 440, optional local favorability module 450, and remote favorability sub system 500.

The advertisement detection module 410 provides programming to detect an advertisement for which a like/dislike signal may be provided by a viewer. In an embodiment, all advertisements displayed on the television 310 may be evaluated by the viewer. In an embodiment, only selected advertisements may be subject to evaluation. In another embodiment. In which the viewer is prompted to register likes or dislikes, the advertisement detection module 410 may operate to initiate the evaluation process. The advertisement detection module 410 includes audio tone generation/detection engine 412, video signal generation/detection engine 414, and trigger detection engine 416. The trigger detection engine 416 detects the display of an advertisement on the television 310. For example, the trigger detection engine 416 may defect the leading edge of an advertisement. In this example, the trigger detection engine 416 then may cause the audio tone generation/detection engine 412 to generate an audio tone that is detectable by the microphones on the tablet 340 or smart phone 360. Alternately, the engine 416 may cause the video signal generation/detection engine 414 to generate a video signal that is detectable by the cameras of the tablet 340 and smart phone 360. A video signal may be useful in environments with high background noise or when the television 310 is muted, for example. In an alternative, both video and audio signals are generated. In response to transmission of the audio tone 315, the audio tone generation/detection engine 416 may wait to receive an acknowledgment signal from the tablet 340 or smart phone 360. When such an acknowledgment signal is not received, an overlay window may be provided on the television screen 311, and the trigger detection engine 416 may signal the overlay display engine 420 to cause the processor 322 of the set top box 320 to display overlay window 316 on the screen 311 of the television 310. An overlay window also may be displayed on the television screen 311 when the advertisement is first detected by the advertisement detection engine 412.

When a prompt is not used, the audio tone may stiff be sent from the television 310 to the tablet 340. Receipt and recognition of the tone at the tablet 340 may enable an alternate process at the tablet 340. For example, recognition of the audio tone may cause the tablet 340 to activate certain keys to allow registering likes and dislikes.

The likeability module 430 includes signal generation engine 432, signal receipt engine 434, favorability display engine 436, and likeability selection engine 438. The signal generation engine 432 generates a like signal or a dislike signal, as appropriate, when the advertisement evaluation process uses viewer inputs from an independent media device such as the tablet 340 or smart phone 360. The signal generation engine 432 also may generate an acknowledgment signal when the signal receipt engine 434 recognizes receipt of the audio signal or video signal. The signal receipt engine 434 recognizes the audio signal or video signal transmitted from the television 310 and detected by the microphone 343 or camera 341, respectively, and provides an Input to the favorability display engine 436. The favorability display engine 436 may render and generate display 352 on the tablet 340 in response to an input from the signal receipt engine 434. The selection engine 438 receives a viewer selection of like or dislike, and provides an input to the signal generation engine 432.

The message format module 440 includes signal receipt engine 442, message format engine 444, and message transmission engine 446. The signal receipt engine 442 receives the like signal or the dislike signal from the tablet 340. The message format engine formats a message to be sent to the clearinghouse service 240 with the like or dislike information, and other information related to display of the advertisement on the television 310. The message transmission engine 446 sends the message from the set top box 320 to the clearinghouse service 240.

The local favorability module 450 determines favorability on the local level—that is, for the advertisements displayed on the television 310 only. The local favorability module 450 includes weighting engine 452, aggregation engine 454, comparison engine 456, ad replacement engine 458, and reporting engine 460. The weighting engine 452 may apply a value to the received like/dislike signal to increase its significance when appropriate. For example, a dislike signal may receive a weighting factor when the dislike signal pertains to the second of three sequential advertisements, with the first and third advertisements receiving a like signal and the second advertisement receiving a dislike signal.

The aggregation engine 454 aggregates, at the local level, like/dislike signals, as weighted, for the same advertisement, advertisements by type, or advertisements by manufacturer/service provider. The aggregation engine 454 may perform the aggregation function for a limited time, such as one month, or without a time limit.

The comparison engine 456 compares the weighted sum of the like/dislike signals to a threshold determined by the advertiser to decide if a specific advertisement, or type or class of advertisements, should be retained or replaced by another advertisements of type or class of advertisements.

The ad replacement engine 458 selects a replacement advertisement, according to prescribed replacement criteria established by the advertiser, from the data store 325.

The reporting engine 460 may format a message to be sent the clearinghouse service 240 when an advertisement is replaced.

FIG. 6B illustrates remote favorability sub system 500. The sub system 500 includes favorability module 510, ad replacement module 530, and report module 550. The favorability module 510 Includes weighting engine 512, optional sorting engine 514, aggregator 516, and analyzer 518. The weighting engine 512 applies a weighting factor a received like/dislike signal to increase its significance when appropriate. For example, a dislike signal may receive a weight when the dislike signal pertains to the second of three sequential advertisements, with the first and third advertisements receiving a like signal and the second advertisement receiving a dislike signal.

The optional sorting engine 514 sorts advertisements into types, categories, by displayed programs, or other criteria. For example, advertisements may be sorted into verticals, and one aspect of the subsequent favorability analysis ranks only those advertisements that are so sorted.

The aggregator 516 may aggregate, globally, like/dislike signals, as weighted, for the same advertisement, advertisements by type, or advertisements by manufacturer/service provider. The aggregator 516 may perform the aggregation function for a limited time, such as one month, or without a time limit

The analyzer 518 compares the weighted sum of the like/dislike signals to a threshold determined by the advertiser and may decide if a specific advertisement, or type or class of advertisements, should be retained or replaced by another advertisements of type or class of advertisements.

The ad replacement module 530 includes comparator 532, ad selection engine 534, and ad replacement engine 536. The comparator 532 compares advertisement metadata for advertisements failing below an established favorability threshold to identify possible replacement advertisements. The data store 245 of the clearinghouse service 240 may Include a ranked list of replacement advertisements for each advertisement being replaced, and, in one embodiment, the comparator 532 may identify the next ranked advertisement while in another embodiment, the comparator 532 may identify a replacement advertisement based on a comparison of metadata between the advertisement to be replaced and the possible replacement advertisements.

The ad selection engine 534 may select an advertisement for replacement based on the output of the comparator 532 and consideration of other criteria such as whether the advertiser has contracted to display the replacement advertisement at a rate commensurate with the advertising slot in which the replacement advertisement would be placed. If the replacement advertisement does not meet this second level of criteria, the ad selection engine 534 may instruct the comparator 532 to identify another candidate replacement advertisement.

The ad replacement engine 536 instructs the advertisement service 210 to retrieve the selected replacement advertisement and deliver the retrieved advertisement for display.

The report module 550 includes report generator engine 552, report template engine 554, and report transmission engine 556. The report generator engine 552 generates an original or first time report for an advertiser and an advertisement. The report may indicate favorability according to a number of criteria as requested by the advertiser. For example, an advertiser may request a report for advertisements shown during specific programs, or during weekends, advertisements shown to specific demographic groups, all advertisements in a specific vertical, and other criteria.

The template engine 554 may create a template of reports based on the original or first report created by the report generator engine 552 such that subsequent report (e.g., weekly) can be created easily.

The report transmission engine 556 may send the completed original and updated reports to the advertisers at an agreed upon periodicity.

In an embodiment, the software system 400 may be distributed among the various devices of FIGS. 2A or 2B. More specifically, and considering FIG. 2B, the advertisement detection module 410, overlay display engine 420, message format module 440, and local favorability module 450 are located in the set top box 320; the likeability module 430 is located in the tablet 340 or smart phone 360; and the favorability subsystem 500 is located in the clearinghouse service 240.

In FIGS. 6A and 6B, the term software system refers to one or more computer programs (also known as a program, module, engine, software, software application, script, or code) that may be used to process and manipulate data, and generate, transmit, receive, and analyze control signals that are used to operate hardware devices, including televisions, smart phones, tablets, computers, and similar hardware devices. A computer program may be written in any form of programming language, including compiled or interpreted languages, declarative or procedural languages. A computer program may be deployed in any form, including as a stand-alone program or as a module, component, subroutine, object, or other unit suitable for use in a computing environment. A computer program may, but need not, correspond to a file in a file system. A computer program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites end interconnected by a communication network. As used in FIGS. 6A and 6B, a software system is a hierarchical structure of one or more software subsystems, modules, and engines.

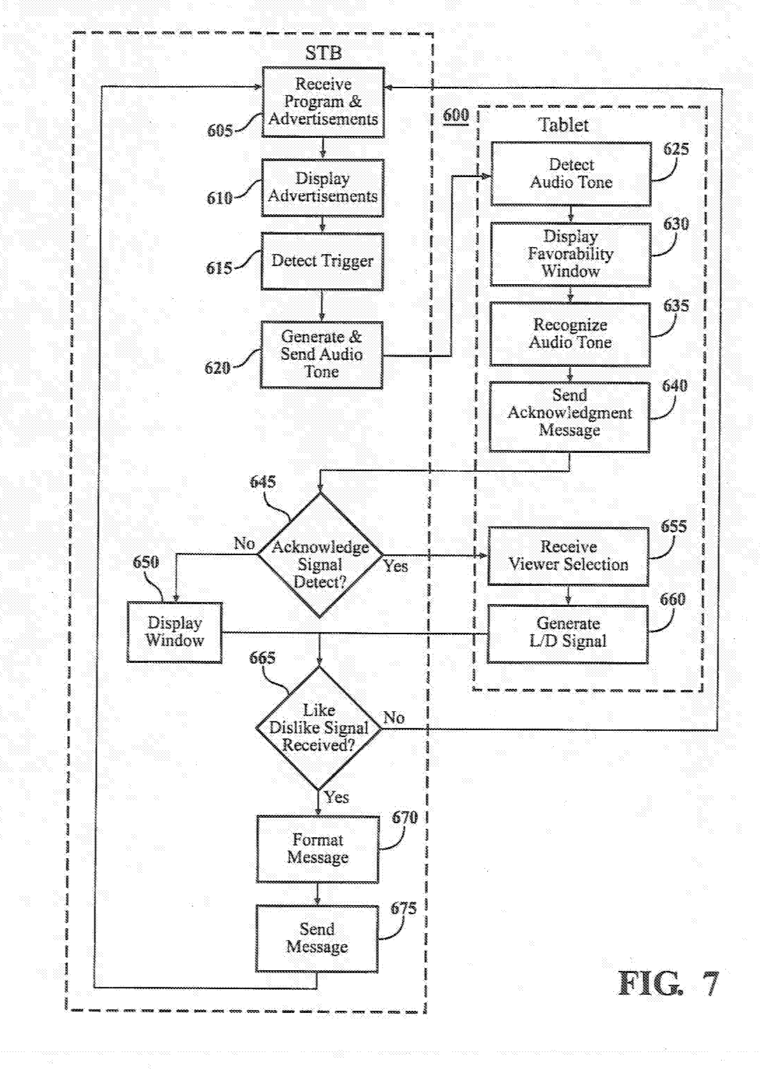

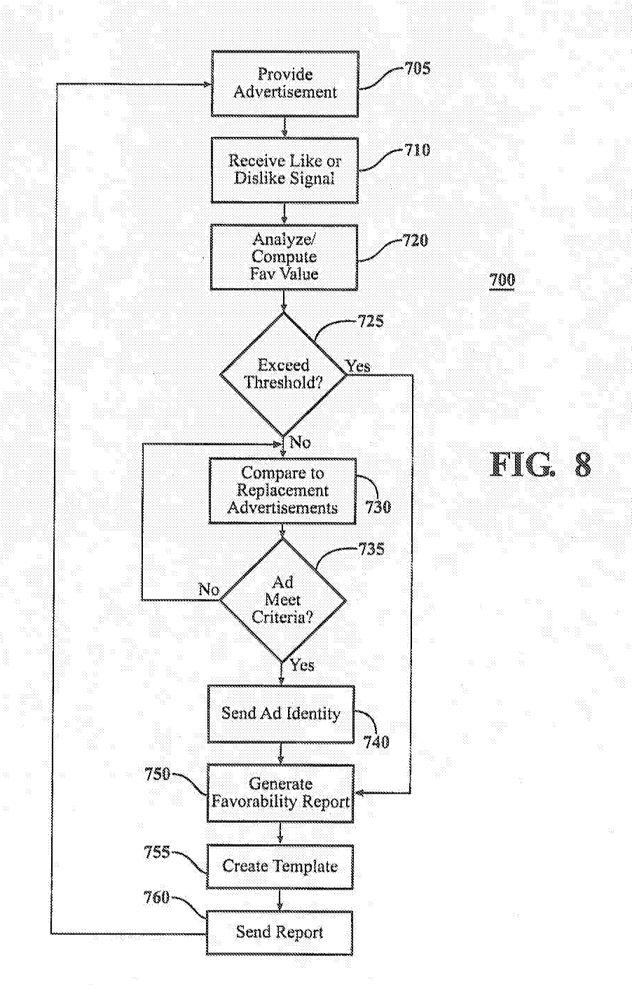

FIGS. 7 and 8 are flow charts illustrating embodiments of methods for providing advertisements to viewers based on viewer feedback. The method of FIG. 7 is based on the environment 30 shown in FIG. 2B. In FIG. 7, method 600 begins in block 605 when the set top box 320 receives programs and advertisements 234 from the program provider 230. In an embodiment, each of the received advertisements may include a trigger that causes the set top box 320 to initiate an evaluation of the advertisement. The trigger may be a specific file or code block, or may simply be the leading edge of the advertisement. In block 610, the set top box 320 displays an advertisement on the television 310. In block 615, which may occur simultaneously with display of the advertisement, the trigger detection engine 416 detects the trigger associated with the displayed advertisement. In block 620, the audio tone generation/detection engine 412 causes the television 310 to generate and emit audio tone 315, which is outside the range of human hearing, but is detectable by microphone 343 of tablet 340.

In block 625, the microphone 343 detects the audio tone 315, which is then recognized by signal receipt engine 434. The signal receipt engine 434 provides a signal received input to the likeability display engine 435, which renders and displays, block 630, rating window 352 on the screen of tablet 340. In block 635, the signal receipt engine 434 may provide an input to the signal generation engine 432 that the audio tone 315 was recognized. In block 640, the signal generation engine 432 sends an acknowledgement signal to the set top box 320.

In block 645, the audio tone generation/detection engine 412 detects, or does not defect, an acknowledgement signal from the tablet 340. If the engine 412 does not detect the acknowledgment signal, the method moves to block 650 and the set top box 320 displays overlay window 316 on the television 310. If, in block 645 the acknowledgment signal is detected, the method 600 moves to block 655. In block 655, the selection engine 438 receives the viewer's selection of like or dislike, and may provide this input to the signal generation engine 432. In block 660, the signal generation engine 432 generates and provides a like or dislike signal to the set top box 320.

Following either block 650 or 680, the method 600 moves to block 665 and the set top box 320 determines If a like or dislike signal was received. If a signal was not received at the set top box 320, the method 600 returns to block 605. If a signal is received at the set top box 320, the method 600 moves to block 670 and the message format engine 444 formats a message to send to the clearinghouse service 240 indicating like or dislike of the advertisement, along with other information such as a time stamp Indicating the date and time the advertisement was displayed, the channel over which the advertisement was delivered, and other information, in block 675, message transmission engine 446 sends the formatted message to the clearinghouse service 240. The method 600 then returns to block 605.

In FIG. 8 method 700 begins in block 705 when an advertiser provides an advertisement for display on a media display device such as the television 310 of FIG. 2A. The display of the advertisement on the television 310 causes the television to display a rating window and causes the set top box 320 to direct the television 310 to emit audio tone 315, which is detectable by tablet 340, and which causes the tablet 340 to display an interactive interface that the viewer uses to signal like or dislike of the displayed advertisement. The like or dislike signal is sent to the set top box 320, which in turn sends the signal as part of a message to the clearinghouse service 240, in block 710, the clearinghouse service 240 receives the like or dislike signal, and stores the signal for processing. In block 715, the favorability module 510 analyzes the received signal to compute a favorability value. In block 725, the analyzer 518 of the favorability module 510 compares the computed favorability value to a threshold established by the advertiser, or the product manufacturer/service provider, to determine if the advertisement should be replaced. If in block 725, the determination is to replace the advertisement, the method 700 moves to block 730. If in block 725, the determination is not to replace the advertisement, the method 700 moves to block 750.

In block 730, the comparator 532 compares data associated with the advertisement with stored criteria for possible replacement advertisements. The replacement advertisements may be from the same advertiser and/or manufacturer/service provider, or from a different advertiser/service provider. The stored criteria may be located in the data store 245. The criteria may simply be a listing of possible replacement advertisements In a priority order, and the comparator 532 identifies the next advertisement in rank order of priority. The priority order may be based an bids submitted for different advertisers for a designated advertising slot, with the highest bid being the highest ranked replacement advertisement. Alternately, a single advertiser may provide a list of preferred replacement advertisements. In another alternative, the criteria may be to replace the advertisement with an advertisement from the same vertical, or from a different vertical. In still another alternative, the possible replacement advertisements include advertisements with computed, historical favorability values, and the replacement advertisements are ranked in order of this favorability value.

In block 735, the ad selection engine 534 selects a replacement advertisement based on the output of the comparator 532 and determines if the selected replacement advertisement meets other criteria, such as price for the proposed advertising slot. If the other criteria are not met, the method 700 returns to block 730 and the comparator selects another replacement advertisement. If, in block 735, the other criteria are met, the method moves to block 740.

In block 740, the ad replacement engine 536 sends an identity of the replacement advertisement lo the advertisement service 210 and instructs the advertisement service 210 to retrieve the identified replacement advertisement and to deliver the advertisement for display. The method 700 then moves to block 750,

In block 750, the report generation engine 552 generates a favorability report that indicates the favorability of the advertisement according to a number of specified criteria, as established by the advertiser, or by the clearinghouse service 240. The favorability report may be customized to suit the needs of the advertiser or may be a generic report. The favorability report may indicate if an advertisement failed to meet an established threshold and was replaced. In block 755, the template engine 554 creates and saves a template corresponding to the favorability report so that subsequent favorability reports may be more readily created. Next, in block 760, the report transmission engine 556 sends the favorability report to the advertiser responsible for the advertisement The method 700 then returns to block 705.

The preceding disclosure refers to a number of flow charts and accompanying descriptions to illustrate the embodiments represented in FIGS. 7 and 8. The disclosed devices, components, and systems contemplate using or implementing any suitable technique for performing the steps illustrated in these figures. Thus, FIGS. 7 and 8 are for illustration purposes only and the described or similiar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

1. A method for providing advertisements to viewers based on viewer feedback, comprising:
providing advertisements for display to a viewer on a first electronic media display device;
receiving a favorability signal for a first advertisement displayed to the viewer, the favorability signal originating from a second electronic media display device independent of the first electronic media display device, the second electronic media display device operated by the viewer, wherein the electronic media display device comprises a display for displaying media;
computing a favorability value from the favorability signal, the favorability value based on additional favorability signals;
comparing the favorability value to a threshold; and
if the favorability value is less than the threshold, replacing the first advertisement with a second advertisement for subsequent display to the viewer.

2. The method of claim 1, wherein the additional favorability signals are received from the viewer for other advertisements displayed to the viewer on the first electronic media display device.

3. The method of claim 2, wherein the additional favorability signals are received from the viewer for advertisements displayed in a same advertisement interval as the first advertisement.

4. The method of claim 1, wherein the additional favorability signals are received from other viewers for the first advertisement.

5. The method of claim 1, wherein the additional favorability signals are received from other viewers for other advertisements displayed to other viewers.

6. The method of claim 5, where in the first advertisement and the other advertisements are in a same vertical.

7. The method of claim 1, wherein the favorability signal is one of a like signal and a dislike signal.

8. The method of claim 1, wherein the favorability signal is a dislike signal.

9. The method of claim 1, further comprising sending the favorability signal from the second electronic media display device to the first electronic display device.

10. The method of claim 9, wherein the favorability value is computed in the first electronic media display device.

11. The method of claim 9, further comprising sending the favorability signal to a clearinghouse service, wherein the clearinghouse service computes the favorability value.

12. The method of claim 1, further comprising sending the favorability signal directly to a clearinghouse service, wherein the clearinghouse service computes the favorability value.

13. The method of claim 1, further comprising storing advertisements for display to the viewer at a location remote from the first and second electronic media display devices.

14. The method of claim 1, further comprising storing advertisements for display to the viewer at the first electronic media display device.

15. A method that provides television advertisements to a viewer based on feedback from the viewer, comprising:
displaying an advertisement on a first media display device;
receiving a dislike signal from a second media display device separate from the media display device, the second media display device comprising a display for displaying media, the dislike signal indicating the viewer dislikes the advertisement; and
replacing the advertisement with a substitute advertisement for subsequent scheduled displays of the advertisement.

16. The method of claim 15, further comprising displaying a rating window overlaying the advertisement, the rating window comprising a dislike tab.

17. The method of claim 16, further comprising:
providing a like tab in the rating window; and
receiving one of a like signal and the dislike signal from the second media display device.

18. The method of claim 17, further comprising:
computing a favorability value comprising a ratio of like signals for the advertisement to dislike signals for the advertisement;
comparing the ratio to a threshold value; and
replacing the advertisement with the substitute advertisement when the ratio is less than the threshold.

19. The method of claim 18, further comprising adding a weighting factor to the favorability value, wherein the weighting factor accounts for favorability values of other advertisements displayed on the first media display device.

20. The method of claim 15, further comprising providing replacement advertisements for storage at the first media display device.

21. The method of claim of claim 15, further comprising:
generating a favorability report for the advertisement; and
sending the favorability report to an owner of a product or service advertised in the advertisement.

22. The method of claim 15, wherein the first media display device is a television and the second media device is one of a tablet, a smart phone, and a portable computer.

23. The method of claim 15, further comprising providing a trigger with the advertisement, the trigger signaling the first media display device to display the favorability window.

24. A computer readable storage medium encoded with a computer program, the program comprising instructions that, when executed by a processor, causes the processor to:
display an advertisement on a first media display device,
receive a dislike signal from a second media display device separate from the first media display device, the second media display device comprising a display for displaying media, the dislike signal indicating the viewer dislikes the advertisement; and
replace the advertisement with a substitute advertisement for subsequent scheduled displays of the advertisement.

25. The computer readable storage medium of claim 24, wherein execution of the instructions causes the processor to display a rating window overlaying the advertisement, wherein the rating window provides a like tab and a dislike tab.
